(19) United States
(12) Patent Application Publication
(10) Pub. No.: US 2019/0202517 A1
(43) Pub. Date: Jul. 4, 2019

(54) THERAPEUTIC MULTI-SEAT BICYCLE

(71) Applicant: Enriqueta Heras, Cathedral City, CA (US)

(72) Inventor: Enriqueta Heras, Cathedral City, CA (US)

(21) Appl. No.: 15/859,336

(22) Filed: Dec. 30, 2017

(51) Int. Cl. B62K 3/12; B62M 3/08; B62J 1/12; B62J 1/18

(52) U.S. Cl. CPC B62K 3/12; B62M 3/083; B62K 2700/54; B62J 1/18; B62J 1/12

(57) ABSTRACT

A therapeutic multi-seat bicycle, including a body, a main seat connected to the body to allow a first user to sit thereupon, a handlebar connected to the body and comprising handles to allow the first user to grip thereonto, an auxiliary seat disposed below the handlebar to allow a second user to sit thereupon, a first wheel disposed at a rear lower portion of the body, a second wheel disposed at a left side of the auxiliary seat, a third wheel disposed at a right side of the auxiliary seat, a fourth wheel disposed at a front lower portion of the body, a plurality of main pedals connected to the first wheel to control rotation of the first wheel in response to rotation of the plurality of main pedals, and a plurality of auxiliary pedals to rotate at a rate slower than the rotation of the plurality of main pedals.

### BACKGROUND OF THE INVENTION

### 1. Field of the Invention

The present general inventive concept relates generally to a bicycle, and specifically, to therapeutic multi-seat bicycle.

### 2. Description of the Related Art

Cycling therapy is a common rehabilitation activity that many physically impaired consumers participate in, as a means to strengthen leg muscles and to promote [blood circulation. However, many individuals may find cycling sessions to be a dreary routine, especially those of a younger age.

Therefore, there is a need for an improved bicycle that offers various therapeutic features for rehabilitation.

### SUMMARY

The present general inventive concept provides an improved bicycle that includes various therapeutic features to rehabilitate patients.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a therapeutic multi-seat bicycle, including a body, a main seat connected to the body to allow a first user to sit thereupon, a handlebar connected to the body and comprising handles to allow the first user to grip thereonto, an auxiliary seat disposed below the handlebar to allow a second user to sit thereupon, a first wheel disposed at a rear lower portion of the body, a second wheel disposed at a left side of the auxiliary seat, a third wheel disposed at a right side of the auxiliary seat, a fourth wheel disposed at a front lower portion of the body, a plurality of main pedals connected to the first wheel to control rotation of the first wheel in response to rotation of the plurality of main pedals, and a plurality of auxiliary pedals to rotate at a rate slower than the rotation of the plurality of main pedals.

The therapeutic multi-seat bicycle may further include a detachable magnetic seat pad to be disposed on the auxiliary seat to provide magnetic therapy to the second user.

The therapeutic multi-seat bicycle may further include a plurality of straps to secure the second user to the auxiliary seat.

The therapeutic multi-seat bicycle may further include a suppressor portion to cause plurality of auxiliary pedals to rotate at a rate slower than the rotation of the plurality of main pedals.

The therapeutic multi-seat bicycle may further include a plurality of straps connected to the plurality of auxiliary pedals to secure feet of the second user to the plurality of auxiliary pedals.

The plurality of auxiliary pedals may cause the fourth wheel to rotate.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a therapeutic multi-seat bicycle, according to an exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the FIGURES and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

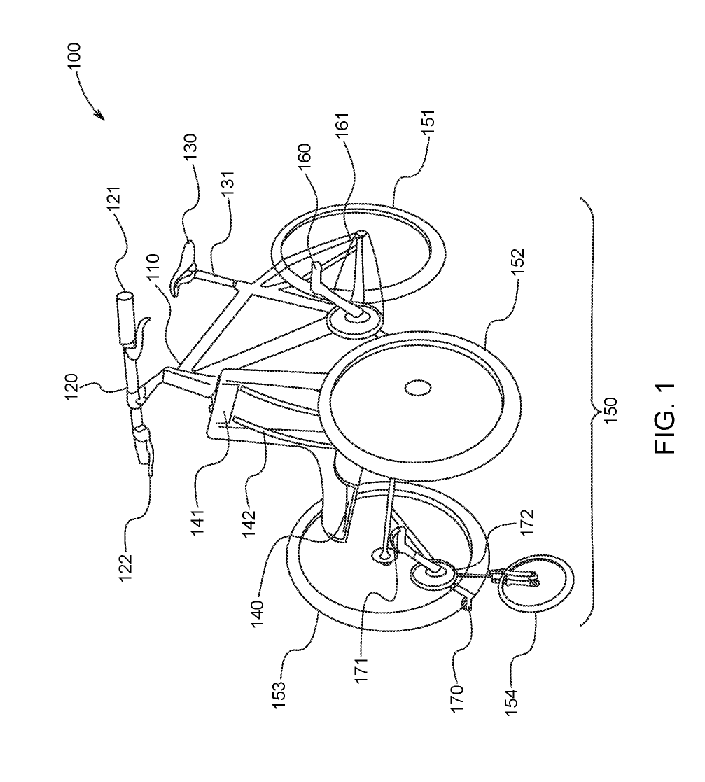

FIG. 1 illustrates a therapeutic multi-seat bicycle 100, according to an exemplary embodiment of the present general inventive concept.

The therapeutic multi-seat bicycle 100, and components thereof, may be constructed from metal, plastic, fiberglass, leather, rubber, ceramic, or any other type of material known to one of ordinary skill in the art.

Referring to FIG. 1, the therapeutic multi-seat bicycle 100 may include a body 110, and a handlebar 120, a main seat 130, an auxiliary seat 140, a plurality of wheels 150, a plurality of main pedals 160, and a plurality of auxiliary pedals 170 all connected to at least a portion of the body 110.

A first user may desire to ride the therapeutic multi-seat bicycle 100, but to do so, the first user may sit in the seat 130, hold onto each of a plurality of handles 121 of the handlebar 120, and place a foot in each of the plurality of main pedals 160.

In order to move the therapeutic multi-seat bicycle 100, the first user may pedal the plurality of main pedals 160, and a chain 161 connected to the plurality of main pedals 160 and a wheel 151 may cause the therapeutic multi-seat bicycle 100 to move. More specifically, as the therapeutic multi-seat bicycle 100 moves, each of wheels 151, 152, 153, and 154 rotate, but the plurality of main pedals 160 may only be connected to one of the wheels 151, 152, 153, and 154 via the chain 161, but is not limited thereto.

The wheel 151 may be connected to and disposed at a rear lower portion of the body 110, the wheel 152 and the wheel 153 may be disposed at side lower portions of the auxiliary seat 140, and the wheel 154 may be disposed at a front lower portion of the body 110.

In order to stop the therapeutic multi-seat bicycle 100 from moving, the first user may squeeze at least one of a plurality of handle brakes 122 disposed on the handles 121 of the handlebar 120.

A second user may sit in the auxiliary seat 140. The auxiliary seat 140 may include an optional detachable magnetic pad 141 that may provide magnetic therapy to the second user. At least one seat belt strap 142 may also be disposed on the auxiliary seat 141 to secure the second user thereon. The second user may place a foot in each of the plurality of auxiliary pedals 170, and the feet of the second user may be secured to the plurality of auxiliary pedals 170 using straps 171.

The plurality of auxiliary pedals 170 may be automated to move at a slower pace than the plurality of main pedals 160, using a suppressor portion 172. More specifically, the suppressor portion 172 may be provided to allow the plurality of auxiliary pedals 170 to rotate at a rate slower than the plurality of main pedals 160, in order to provide therapy to the second user. The suppressor portion 172 may be adjustable to allow the plurality of auxiliary pedals 170 to rotate at various speeds, based on needs or desires of the second user.

The suppressor portion 172 may be connected to the wheel 154, and may cause the plurality of auxiliary pedals 170 to rotate at a fraction of a rotation rate of the wheel 154. Alternatively, the plurality of auxiliary pedals 170 may actually be used by the second user to rotate the wheel 154, to provide additional therapy to the user and to help the first user move the therapeutic multi-seat bicycle 100.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A therapeutic multi-seat bicycle, comprising:
a body;
a main seat connected to the body to allow a first user to sit thereupon;
a handlebar connected to the body and comprising handles to allow the first user to grip thereonto;
an auxiliary seat disposed below the handlebar to allow a second user to sit thereupon;
a first wheel disposed at a rear lower portion of the body;
a second wheel disposed at a left side of the auxiliary seat;
a third wheel disposed at a right side of the auxiliary seat;
a fourth wheel disposed at a front lower portion of the body;
a plurality of main pedals connected to the first wheel to control rotation of the first wheel in response to rotation of the plurality of main pedals; and
a plurality of auxiliary pedals to rotate at a rate slower than the rotation of the plurality of main pedals.

2. The therapeutic multi-seat bicycle of claim 1, further comprising:
a detachable magnetic seat pad to be disposed on the auxiliary seat to provide magnetic therapy to the second user.

3. The therapeutic multi-seat bicycle of claim 1, further comprising:
a plurality of straps to secure the second user to the auxiliary seat.

4. The therapeutic multi-seat bicycle of claim 1, further comprising:
a suppressor portion to cause plurality of auxiliary pedals to rotate at a rate slower than the rotation of the plurality of main pedals.

5. The therapeutic multi-seat bicycle of claim 1, further comprising:
a plurality of straps connected to the plurality of auxiliary pedals to secure feet of the second user to the plurality of auxiliary pedals.

6. The therapeutic multi-seat bicycle of claim 1, wherein the plurality of auxiliary pedals cause the fourth wheel to rotate.
